(19) United States
(12) Patent Application Publication
(10) Pub. No.: US 2025/0102740 A1
(43) Pub. Date: Mar. 27, 2025

(54) V-GROOVE FIBER STOP

(71) Applicant: Intel Corporation, Santa Clara, CA (US)

(72) Inventors: Harel FRISH, Albuquerque, NM (US); Hari MAHALINGAM, San Jose, CA (US); Saeed FATHOLOLOUMI, Los Gatos, CA (US); Shane YERKES, Placitas, NM (US); John HECK, Berkeley, CA (US); Wei QIAN, Walnut, CA (US)

(21) Appl. No.: 18/373,851

(22) Filed: Sep. 27, 2023

(51) Int. Cl. G02B 6/36

(52) U.S. Cl. CPC G02B 6/3636; G02B 6/3692

(57) ABSTRACT

A device comprising a silicon substrate and a waveguide on the silicon substrate. A groove is in the substrate, the groove having a sloped rear wall adjacent to the waveguide. A trench is in the substrate, the trench along a second direction generally orthogonal to the first direction across the sloped rear wall, the trench having a vertical wall at an intersection with the sloped rear wall. An optical fiber in the groove with one end of the optical fiber abutting the vertical wall.

### BACKGROUND

Today's consumer electronics market frequently demands complex functions requiring very intricate circuitry. Scaling to smaller and smaller fundamental building blocks, e.g. transistors, has enabled the incorporation of even more intricate circuitry on a single die with each progressive generation. Semiconductor packages are used to protect an integrated circuit (IC) chip or die, and provide the die with an electrical interface to external circuitry. With the increasing demand for smaller electronic devices, semiconductor packages are designed to be even more compact and must support larger circuit density.

For example, a trend in semiconductor packages is to move optical interconnects into the package to interface directly with a logic chip for increased data transfer speeds transmitting using light. An optical interconnect may include a photonic integrated circuit (PIC) connected to a processor or memory connected to external components through an optical fiber array and corresponding optical connectors or ferrules. One problem is that optical interconnect packages need less than sub-um alignment accuracy to align the optical fibers to the on-chip photonics waveguide. A V-groove array is a passive alignment structure that has become a standard approach for aligning optical fibers to photonic integrated circuits. However, there is an issue of how to ensure that the ends of the optical fibers are situated in the optimal position with respect to the optical input/output facet or waveguide of the PIC. Arrays of the optical fibers need to be assembled simultaneously to achieve high-volume assembly, which makes meeting the alignment accuracy requirement a significant challenge for yield.

### BRIEF DESCRIPTION OF THE DRAWINGS

FIGS. 1A-1E illustrate an example of a silicon v-groove structure for integrating an optical interconnect or a fiber connector in an optical interconnect semiconductor package.

FIGS. 2 and 3 illustrate a groove alignment structure comprising a groove having an X-stop for integrating an optical interconnect or a fiber connector in an optical interconnect package according to the disclosed embodiments.

FIG. 4 further illustrates a wafer-level sort trench along the second direction across the set of grooves.

FIGS. 5A-5D are cross-section diagrams illustrating an exemplary process flow for fabricating a groove alignment structure according to the disclosed embodiments.

FIGS. 6A and 6B are diagrams illustrating a wafer and one or more dies having integrated circuit (IC) structures formed on the surface of the wafer.

FIG. 7 illustrates a block diagram of an electronic system, in accordance with an embodiment of the present disclosure.

FIG. 8 is a cross-sectional side view of an integrated circuit (IC) device assembly that may include one or more groove alignment structures, in accordance with one or more of the embodiments disclosed herein.

FIG. 9 illustrates a computing device in accordance with one implementation of the disclosure.

### DESCRIPTION OF THE EMBODIMENTS

Groove alignment structures and manufacturing processes for z-direction alignment of optical fibers with a photonic integrated circuit are described. In the following description, numerous specific details are set forth, such as specific material and tooling regimes, in order to provide a thorough understanding of embodiments of the present disclosure. It will be apparent to one skilled in the art that embodiments of the present disclosure may be practiced without these specific details. In other instances, well-known features, such as single or dual damascene processing, are not described in detail in order to not unnecessarily obscure embodiments of the present disclosure. Furthermore, it is to be understood that the various embodiments shown in the Figures are illustrative representations and are not necessarily drawn to scale. In some cases, various operations will be described as multiple discrete operations, in turn, in a manner that is most helpful in understanding the present disclosure, however, the order of description should not be construed to imply that these operations are necessarily order-dependent. In particular, these operations need not be performed in the order of presentation.

Certain terminology may also be used in the following description for the purpose of reference only, and thus are not intended to be limiting. For example, terms such as “upper”, “lower”, “above”, “below,” “bottom,” and “top” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

There is an increased need for techniques to integrate optical fiber connectors with a flip-chip package. One or more embodiments described herein are directed to groove alignment structures and manufacturing processes for z-direction alignment of optical fibers with a photonic integrated circuit.

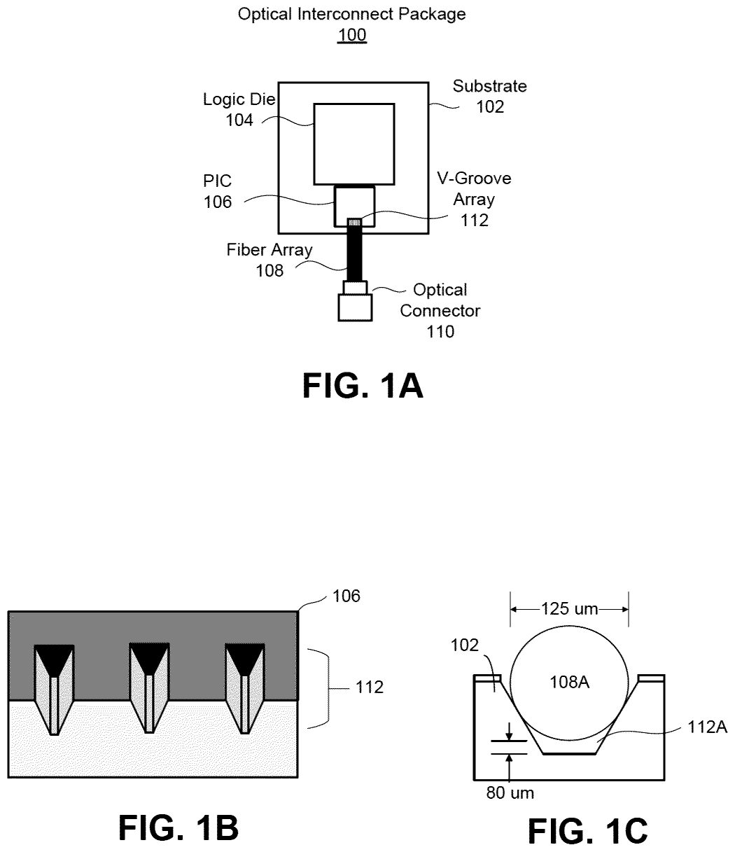

To provide context, FIGS. 1A-1C illustrates an example V-groove architecture for integrating an optical fiber connector in an optical interconnect semiconductor package. FIG. 1A illustrates a top view of the optical interconnect package 100, which may include a logic die 104 mounted to a polymer substrate 102. A PIC 106 is mounted on the polymer substrate 102 and is connected to the logic die 104 through the polymer substrate 102. The PIC 106 is further connected to external components through an optical fiber array 108 and a corresponding optical connector 110 also called a ferrule. The optical interconnect package 100 needs less than 1 μm alignment accuracy to align the optical fibers comprising the fiber array 108 to the PIC 106.

For example, in one embodiment, the PIC 106 may provide a Terabit/s optical physical layer to support high-bandwidth, low-latency connectivity. In one embodiment, the PIC 106 refers to a single die. In another embodiment, the PIC 106 may be included in a photonic multi-chip package with laser and electronic control chips. The PIC 106 may be mounted to substrate 102 through micro-bumps or other contacts and may be connected to the logic die 104 through interconnects within substrate 102. In one embodiment, the PIC 106 may have a body comprising a silicon substrate and a photonic device layer formed on the silicon substrate. In some embodiments, PIC 106 may comprise a Silicon On Insulator (SOI) substrate having a silicon substrate, a thick oxide layer on the substrate, and a silicon layer having photonic devices on the oxide layer. In one example, PIC 106 may have a thickness of approximately 75 μm.

FIG. 1B illustrates a front, close-up view of an edge of PIC 106 showing that existing solutions use a V-groove array 112 to guide and align the fiber array 108 into the PIC 106. The V-groove array 112 may be fabricated by wet non-isotropic etching of the silicon substrate of the PIC 106. Each groove or V-groove may have a cross-section that is U-shaped, square-shaped, or V-shaped.

FIG. 1C illustrates a front view of one of the V-grooves showing that respective optical fibers in the fiber array 108 are inserted into corresponding V-grooves 112A. Sidewalls of each V-groove 112A are etched at a certain degree angle to a depth of approximately 80 μm deep, and each V-groove 112A may have a width that is approximately equal to the diameter of the optical fibers. After an optical fiber 108A is inserted, a compressor plate (not shown) then presses on top of the optical fiber 108A to push the fiber down in the V-groove 12A so that the center of the optical fiber 108A is aligned with the waveguide that emits light from the side of the PIC (the PIC “facet”) 106. In this example, each optical fiber 108A in the fiber array 108 may have a diameter of approximately 125 μm and there may be a gap (e.g., ˜17.5 μm) between the optical fiber 108A and the bottom of the V-groove 112A.

FIGS. 1D and 1E are top and cross-section views, respectively, of the V-groove 112A. Optical fiber 108A is shown transparent in FIG. 1D so that the bottom of the V-groove 112A is viewable. Because the non-isotropic etching process to form the V-grooves uses the <111> crystal plane of the silicon substrate 106A of the PIC 106 as an etch stop, each V-groove 112A is formed with two sloped sidewalls 114A, a sloped rear wall 114B adjacent to the waveguide 116, and a bottom 114C. The optical fiber 108A is shown inserted into the V-groove 112A and facing a waveguide 116 on the PIC 106 at or near the top of the rear wall 114B. The waveguide 116 is a channel that guides light, which is emitted by an end face of the waveguide called a facet. The waveguide 116 can be made from a variety of materials, including silicon, silicon nitride, and indium phosphide.

As shown in FIG. 1E, due to the sloped rear wall 114B at the end of the V-groove 112A, once the optical fiber 108A is inserted and pushed in the x-direction (along the optical fiber axis) towards waveguide 116, the optical fiber 108A hits the sloped rear wall 114B and stops. The distance between the facet of the PIC 106 to the inserted optical fiber 108A is approximately 60 μm. Unfortunately, at that distance, there is a loss of light that enters the optical fiber 108A from the facet. To prevent light loss, the optical fiber 108A should be within a distance of 20 μm from the waveguide.

While V-grooves are well known for ensuring sufficient x-y alignment of the optical fiber, what is needed is an improved groove alignment structure that ensures accurate positioning of the optical fibers in the x-direction in close proximity to the waveguide. Such a groove alignment structure should also reduce the risk of the optical fiber colliding with the PIC facet and damaging both the optical fiber and the PIC facet.

In accordance with the disclosed embodiments, improved groove alignment structures and manufacturing processes for x-direction alignment of optical fibers with a waveguide of a PIC are described. Embodiments disclose groove alignment structures with a novel X-stop built into the groove that effectively controls the x-direction alignment of optical fibers with a PIC. In embodiments, an X-stop is formed by creating a fiber stop trench across the sloped rear wall of a groove. The fiber stop trench forms a vertical wall at an intersection with the sloped rear back wall in close proximity to the waveguide, which defines the X-stop. An optical fiber inserted into the groove alignment structure abuts the X-stop rather than the rear wall. The use of the X-stop ensures that the optical fiber is at a distance of 10-20 μm from the waveguide. In addition, the fiber stop ensures that the optical fiber cannot be pushed forward in the x-direction so far that the fiber contacts the waveguide, which prevents potential damage to the waveguide and improves the yield of the PIC 106.

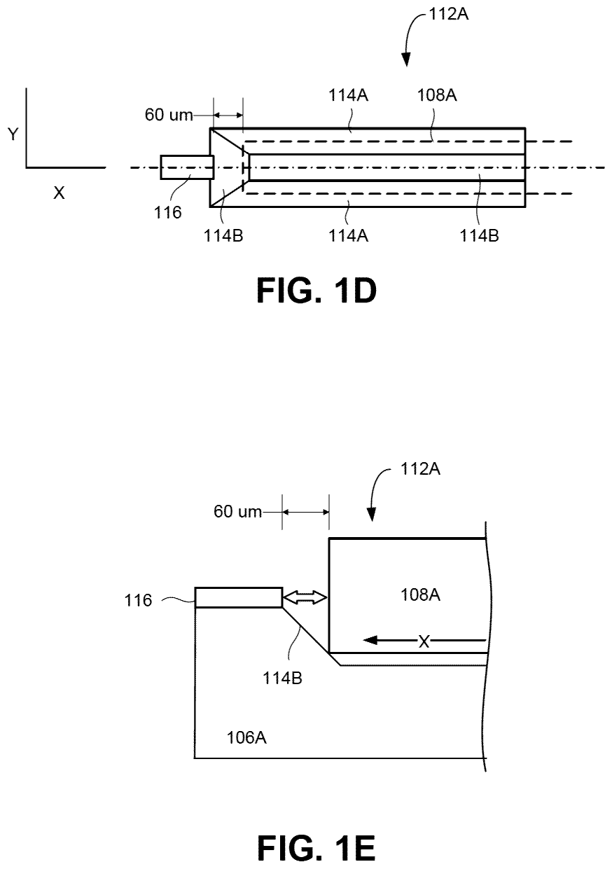

FIGS. 2 and 3 illustrate an example of a groove alignment structure comprising a groove having an X-stop for integrating an optical interconnect or a fiber connector in an optical interconnect package, such as optical interconnect package 100. Groove 212 is representative of the grooves comprising a groove array that is intended to replace V-groove array 112 of FIG. 1B. FIG. 2 illustrates a cross-section view of the groove 212 holding an inserted optical fiber 208.

According to the disclosed embodiments, similar to FIGS. 1A and 1B, a device, such as the groove alignment structure 200, includes a substrate 206 (e.g., silicon) of a PIC. A waveguide 216 is on the substrate 206. A groove 212 is along a first direction and the groove includes a sloped rear wall 214B adjacent to the waveguide 216. A trench 220 is in the substrate 206 along a second direction generally orthogonal (+−10%) to the first direction across the sloped rear wall 214B. The trench 220 forms a vertical wall at an intersection with the respective sloped back wall to create an X-stop 222. An optical fiber 208 is in the groove 212 with one end of the optical fiber 208 abutting the vertical wall.

The groove 212 is part of a groove array and an adhesive material (not shown) may be located in the bottom of the groove 212. Optical fibers 208 may comprise part of an optical fiber array, which is in the set of grooves over the adhesive material, and a portion of each of the optical fibers extends or rises above the substrate 206.

In embodiments, the X-stop 222 is designed to contact the cladding, rather than the optical core, of the optical fiber 208. This ensures that the optical fiber 208 can be inserted repeatably to a specified x-direction from the waveguide 216 without hitting or damaging the fiber core of the optical fiber 208.

The X-stop 222 also ensures that the longest fiber in an optical fiber array is always less than 60 μm from the facet of waveguide 216. As shown in FIG. 2, the vertical wall defining the X-stop 222 is between 10-20 μm from the waveguide 216. Consequently, there is a distance of 10-20 μm between optical fiber 208 and waveguide 216, and a gap is maintained between the optical fiber 208 and waveguide 216.

In one embodiment, the fiber stop trench 220 that forms X-stop 222 may comprise a single continuous fiber trench that extends across each groove 212 of a plurality of grooves. In an alternative embodiment, the fiber stop trench 220 may be non-continuous so that each groove 212 of a plurality of grooves includes a respective fiber stop trench 220.

According to disclosed embodiments, the X-stop 222 provides effective x-direction alignment of optical fibers to waveguide 216 on the substrate 206. Even if mechanical assembly dictates the need to push optical fiber 208 closer to waveguide 216 than normal, the X-stop 222 will protect the facet of the waveguide 216 from the scratched or destroyed through contact with optical fiber 208, which also makes sure that the optical quality of the optical fiber and PIC facet are not compromised.

FIG. 3 illustrates a cross-section view of the groove 212 without the optical fiber 208 showing the groove 212 with the fiber stop trench and an optional wafer-level sort trench 402 in substrate 206 adjacent to the fiber stop trench 220. A wafer-level sort trench is a trench etched into the substrate to define the boundaries of individual die (e.g., the PIC) and to facilitate the separation of the die from the wafer after wafer-level testing. In one embodiment, the wafer-level sort trench 402 is a single continuous trench that extends across a plurality of grooves

The fiber stop trench 220 and the wafer-level sort trench 402 may be formed at the same time after the formation of the groove through a single dry etch process. In one embodiment, the wafer-level sort trench 402 is etched to a deeper depth than the fiber stop trench 220. For example, in one embodiment, the fiber stop trench 220 may be between approximately 150-200 μm deep, while the wafer-level sort trench 402 may range from a depth of 180-260 μm, with regions of the wafer-level sort trench 402 between the grooves being shallower than regions of the wafer-level sort trench 402 etched into the bottom of the grooves 212.

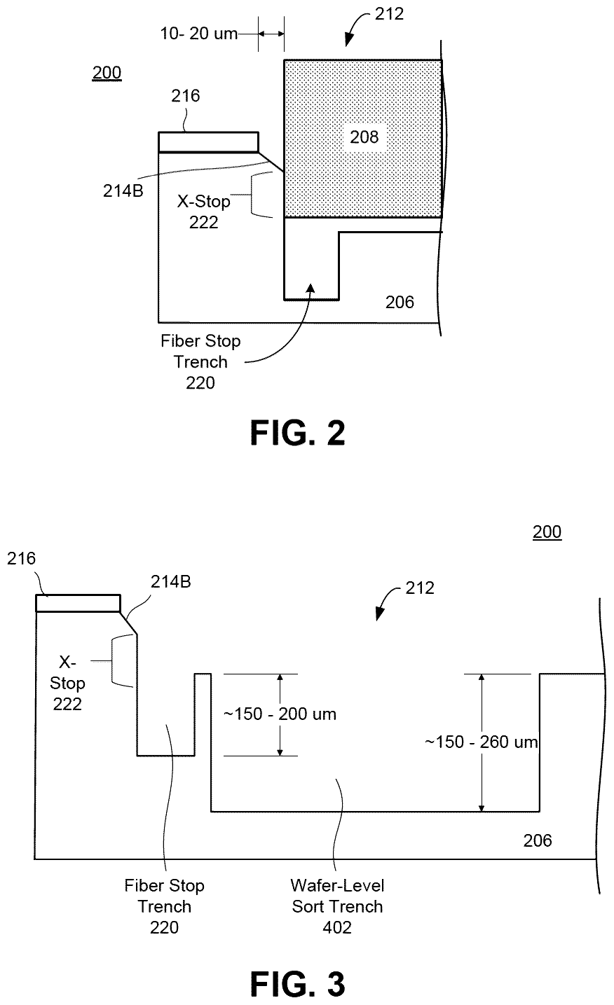

FIG. 4 illustrates an angled side-view of PIC 206 and a groove array comprising a set of grooves 404 adjacent to a waveguide 216. FIG. 4 also illustrates an enlarged view of groove 212 in the set of grooves 404.

PIC 206 comprises a substrate and the set of grooves 404 is along a first direction on the top surface of the substrate aligned with waveguide 216. As shown in the enlarged view, each groove 212 has two sloped side walls 414A and 414B, and a sloped rear wall 214B adjacent to waveguide 216. A set of one or more fiber stop trenches 220 is along a second direction generally orthogonal to the first direction extending across the sloped rear walls 214B of the grooves 212. As described above, one or more fiber stop trenches 220 each form a vertical wall at an intersection with the sloped rear walls 214B of the grooves 212 to create respective X-stops. Once a respective optical fiber (not shown) is inserted into each groove 212, one end of the respective optical fiber abuts the vertical wall (X-stop) of the groove 212. The vertical wall defines a distance of 10-20 μm between the optical fiber and the waveguide 216.

FIG. 4 further shows a wafer-level sort trench 402 along the second direction across the set of grooves 404. In this embodiment, the fiber stop trench 220 is non-continuous so that grooves in the set of grooves 404 include a respective fiber stop trench. The wafer-level sort trench 402 is shown as continuous and extending across the set of grooves 404. The wafer-level sort trench 402 is located so that a gap exists between the wafer-level sort trench 402 and the vertical wall. In one embodiment, the wafer-level sort trench 402 may be located approximately 50-60 μm from the fiber stop trench 220. The wafer-level sort trench 402 effectively separates the groove 212 into two parts to form a first groove 212A and a second groove 212B. In one embodiment, the second groove 12B may be approximately 800 μm in length.

In one embodiment, the optical fibers may have a diameter of approximately 80-125 μm and a pitch of approximately 125-250 μm. The set of grooves 404 may each have a width approximately equal to the diameter of the optical fibers.

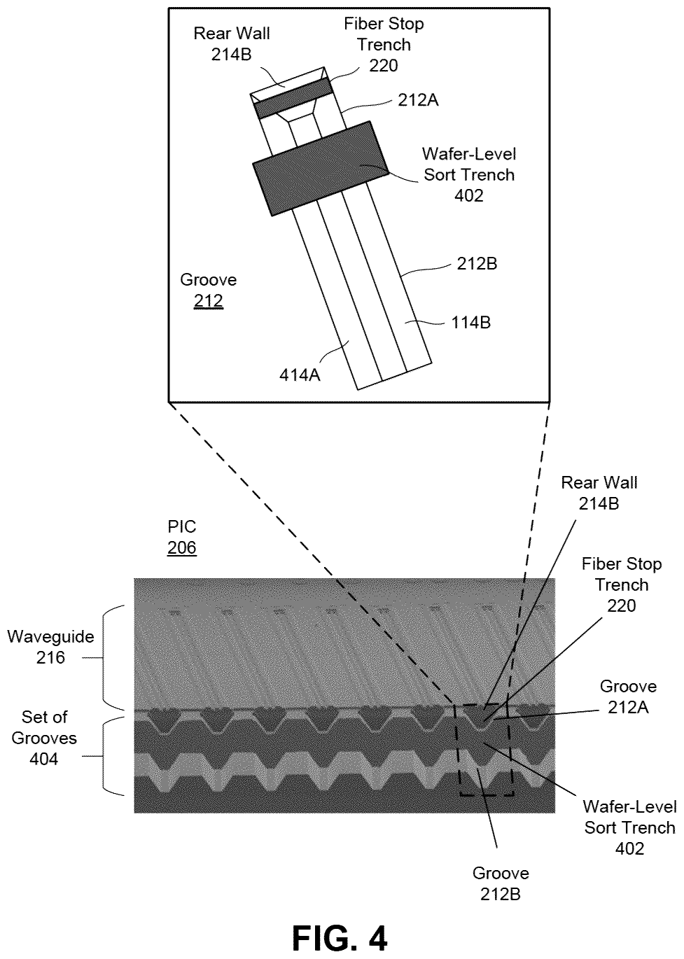

FIGS. 5A-5D are cross-section diagrams illustrating an exemplary process flow for fabricating a groove alignment structure according to the disclosed embodiments. FIG. 5A shows that the process may begin by performing a first etch process through a dielectric stack (not shown) of PIC 506 having a waveguide 516 to expose the substrate 506A of the PIC 506 where grooves will be formed. In one embodiment, the substrate 506A comprises silicon (Si) but may comprise other materials including, but not limited to: silicon germanium (SiGe), silicon-on-insulator (SOI), and group III-V semiconductors.

In embodiments, the first etch process may be performed by a dry etch (e.g., a reactive-ion etch) or a laser etching process. Laser etching, if used, may also allow groove creation after the PIC is attached to a package (e.g., package 100), which reduces the risk of the PIC cracking. Any type of dry etching process that etches directionally or anisotropically may be used. Optionally, a wet etch may be used in place of a dry etch. The etching process is performed after an etch mask is formed using known photolithographic methods. In certain embodiments, the etch mask may be a hard mask of silicon dioxide or silicon nitride; and in other embodiments, the etch mask is made from known photoresist materials.

FIG. 5B shows that a second etch process is performed through the etch mask to form openings in the substrate 506A that define locations, widths, and lengths of a plurality of grooves along a first direction (e.g., along an axis of the waveguide) of the substrate. The second etch process may be performed such that each groove 512 in the plurality of grooves has sloped sidewalls, a bottom, and a sloped rear wall 514. The second etch process defines X and Y alignment for an optical fiber array. Once inserted into the grooves, the optical fibers move within a plane (X) of the substrate 206A (see FIG. 1D).

In embodiments, the second etch process may be performed by crystallographic silicon wet etching using a Tetramethylammonium hydroxide (TMAH) or a KOH etching process. The substrate 506A is wet etched for a predetermined amount of time to form the grooves to a desired depth, e.g., 80 μm.

FIG. 5C shows that after the second etch is performed to form the grooves 512, a third etch process is performed to create a fiber stop trench 520 across the rear wall 514 of the grooves adjacent to waveguide 516. Fiber stop trench 520 forms a vertical wall at an intersection with the sloped rear wall 514 to create an X-stop 522. The vertical wall or X-stop 522 of the fiber stop trench formed in the rear wall 514 defines the distance between the end of waveguide 516 and the end of an optical fiber inserted into the corresponding groove. In embodiments, the third etch process may be performed by a dry etch (e.g., a reactive-ion etch) or a laser etching process. In embodiments, the third etch process used to create the fiber stop trench 520, may also be used to create the wafer-level sort trench shown in FIG. 4.

FIG. 5D shows that after the third etch process, an adhesive material 526 is optionally dispensed into the bottom of each of the grooves 512, and an optical fiber 508 of an optical fiber array is inserted into respective ones of the grooves 512 onto the adhesive material 526. Approximately one-half of each of the optical fiber 508 extends above the surface of the substrate 506A. The resultant groove alignment structure can then be covered by a polymer lid (not shown).

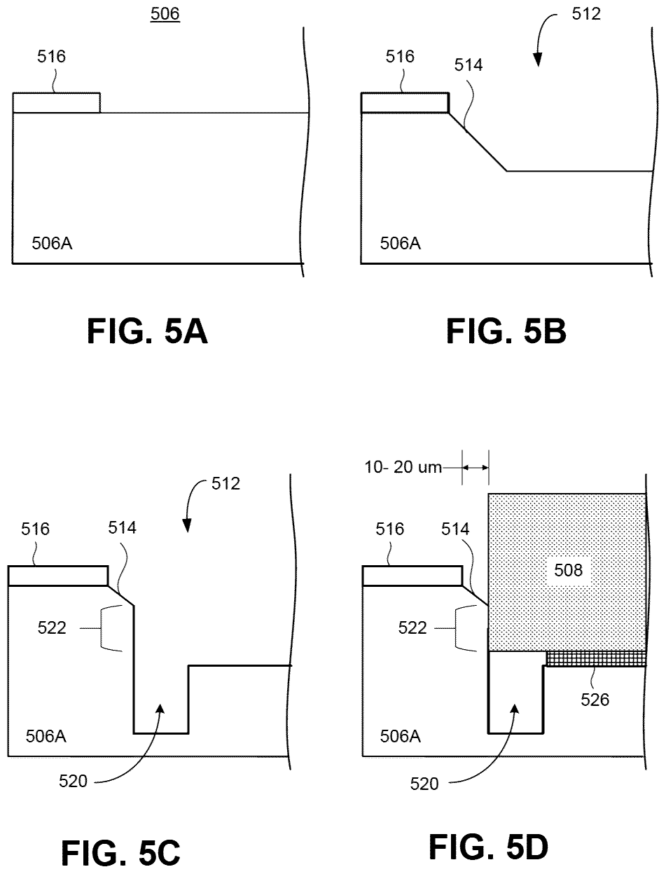

Referring to FIGS. 6A and 6B, a wafer 600 may be composed of semiconductor material and may include one or more dies 602 having integrated circuit (IC) structures formed on the surface of the wafer 600. Each of the dies 602 may be a repeating unit of a semiconductor product that includes any suitable IC (e.g., ICs including a substrate with V-grooves and corresponding fiber stop trenches that form X-stops, such as described above. After the fabrication of the semiconductor product is complete, the wafer 600 may undergo a singulation process in which each of the dies 602 is separated from one another to provide discrete “chips” of the semiconductor product. In particular, structures that include embedded non-volatile memory structures having a substrate with V-grooves and corresponding fiber stop trenches that form X-stops as disclosed herein may take the form of the wafer 600 (e.g., not singulated) or the form of the die 602 (e.g., singulated). The die 602 may include one or more embedded non-volatile memory structures and/or supporting circuitry to route electrical signals, as well as any other IC components. In some embodiments, the wafer 600 or the die 602 may include an additional memory device (e.g., a static random access memory (SRAM) device), a logic device (e.g., an AND, OR, NAND, or NOR gate), or any other suitable circuit element. Multiple ones of these devices may be combined on a single die 602. For example, a memory array formed by multiple memory devices may be formed on the same die 602 as a processing device or other logic that is configured to store information in the memory devices or execute instructions stored in the memory array.

Embodiments disclosed herein may be used to manufacture a wide variety of different types of integrated circuits and/or microelectronic devices. Examples of such integrated circuits include, but are not limited to, processors, chipset components, graphics processors, digital signal processors, micro-controllers, and the like. In other embodiments, semiconductor memory may be manufactured. Moreover, integrated circuits or other microelectronic devices may be used in a wide variety of electronic devices known in the arts. For example, in computer systems (e.g., desktop, laptop, server), cellular phones, personal electronics, etc. The integrated circuits may be coupled with a bus and other components in the systems. For example, a processor may be coupled by one or more buses to a memory, a chipset, etc. Each of the processor, the memory, and the chipset, may potentially be manufactured using the approaches disclosed herein.

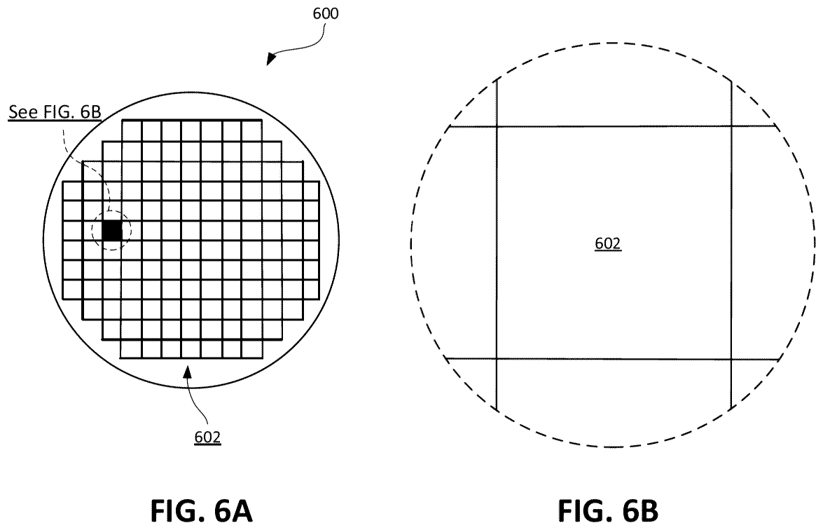

FIG. 7 illustrates a block diagram of an electronic system 700, in accordance with an embodiment of the present disclosure. The electronic system 700 can correspond to, for example, a portable system, a computer system, a process control system, or any other system that utilizes a processor and an associated memory. The electronic system 700 may include a microprocessor 702 (having a processor 704 and control unit 706), a memory device 708, and an input/output device 710 (it is to be appreciated that the electronic system 700 may have a plurality of processors, control units, memory device units and/or input/output devices in various embodiments). In one embodiment, the electronic system 700 has a set of instructions that define operations that are to be performed on data by the processor 704, as well as, other transactions between the processor 704, the memory device 708, and the input/output device 710. The control unit 706 coordinates the operations of the processor 704, the memory device 708 and the input/output device 710 by cycling through a set of operations that cause instructions to be retrieved from the memory device 708 and executed. The memory device 708 can include a non-volatile memory cell as described in the present description. In an embodiment, the memory device 708 is embedded in the microprocessor 702, as depicted in FIG. 7. In an embodiment, the processor 704, or another component of electronic system 700, includes a substrate with V-grooves and corresponding fiber stop trenches that form X-stops, such as those described herein.

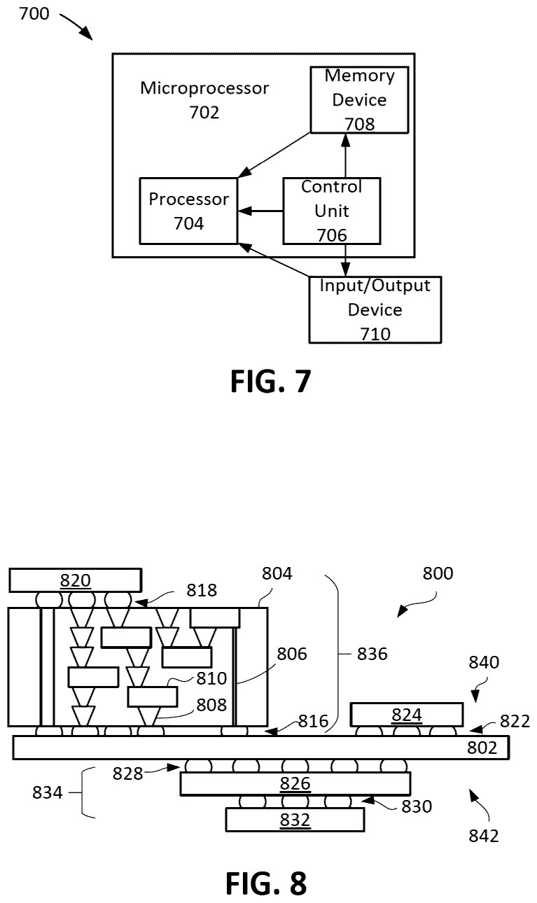

FIG. 8 is a cross-sectional side view of an integrated circuit (IC) device assembly that may include a substrate with V-grooves and corresponding fiber stop trenches that form X-stops, in accordance with one or more of the embodiments disclosed herein.

Referring to FIG. 8, an IC device assembly 800 includes components having one or more integrated circuit structures described herein. The IC device assembly 800 includes a number of components disposed on a circuit board 802 (which may be, e.g., a motherboard). The IC device assembly 800 includes components disposed on a first face 840 of the circuit board 802 and an opposing second face 842 of the circuit board 802. Generally, components may be disposed on one or both faces 840 and 842. In particular, any suitable ones of the components of the IC device assembly 800 may include a number of a multilayer high-k gate dielectric, such as disclosed herein.

In some embodiments, the circuit board 802 may be a printed circuit board (PCB) including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 802. In other embodiments, the circuit board 802 may be a non-PCB substrate.

The IC device assembly 800 illustrated in FIG. 8 includes a package-on-interposer structure 836 coupled to the first face 840 of the circuit board 802 by coupling components 816. The coupling components 816 may electrically and mechanically couple the package-on-interposer structure 836 to the circuit board 802, and may include solder balls (as shown in FIG. 8), male and female portions of a socket, an adhesive, an underfill material, and/or any other suitable electrical and/or mechanical coupling structure.

The package-on-interposer structure 836 may include an IC package 820 coupled to an interposer 804 by coupling components 818. The coupling components 818 may take any suitable form for the application, such as the forms discussed above with reference to the coupling components 816. Although a single IC package 820 is shown in FIG. 8, multiple IC packages may be coupled to the interposer 804. It is to be appreciated that additional interposers may be coupled to the interposer 804. The interposer 804 may provide an intervening substrate used to bridge the circuit board 802 and the IC package 820. The IC package 820 may be or include, for example, a die (the die 602 of FIG. 6B), or any other suitable component. Generally, the interposer 804 may spread a connection to a wider pitch or reroute a connection to a different connection. For example, the interposer 804 may couple the IC package 820 (e.g., a die) to a ball grid array (BGA) of the coupling components 816 for coupling to the circuit board 802. In the embodiment illustrated in FIG. 8, the IC package 820 and the circuit board 802 are attached to opposing sides of the interposer 804. In other embodiments, the IC package 820 and the circuit board 802 may be attached to the same side of the interposer 804. In some embodiments, three or more components may be interconnected by way of the interposer 804.

The interposer 804 may be formed of an epoxy resin, a fiberglass-reinforced epoxy resin, a ceramic material, or a polymer material such as polyimide. In some implementations, the interposer 804 may be formed of alternate rigid or flexible materials that may include the same materials described above for use in a semiconductor substrate, such as silicon, germanium, and other group III-V and group IV materials. The interposer 804 may include metal interconnects 810 and vias 808, including but not limited to through-silicon vias (TSVs) 806. The interposer 804 may further include embedded devices, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio-frequency (RF) devices, power amplifiers, power management devices, antennas, arrays, sensors, and microelectromechanical systems (MEMS) devices may also be formed on the interposer 804. The package-on-interposer structure 836 may take the form of any of the package-on-interposer structures known in the art.

The IC device assembly 800 may include an IC package 824 coupled to the first face 840 of the circuit board 802 by coupling components 822. The coupling components 822 may take the form of any of the embodiments discussed above with reference to the coupling components 816, and the IC package 824 may take the form of any of the embodiments discussed above with reference to the IC package 820.

The IC device assembly 800 illustrated in FIG. 8 includes a package-on-package structure 834 coupled to the second face 842 of the circuit board 802 by coupling components 828. The package-on-package structure 834 may include an IC package 826 and an IC package 832 coupled together by coupling components 830 such that the IC package 826 is disposed between the circuit board 802 and the IC package 832. The coupling components 828 and 830 may take the form of any of the embodiments of the coupling components 816 discussed above, and the IC packages 826 and 832 may take the form of any of the embodiments of the IC package 820 discussed above. The package-on-package structure 834 may be configured in accordance with any of the package-on-package structures known in the art.

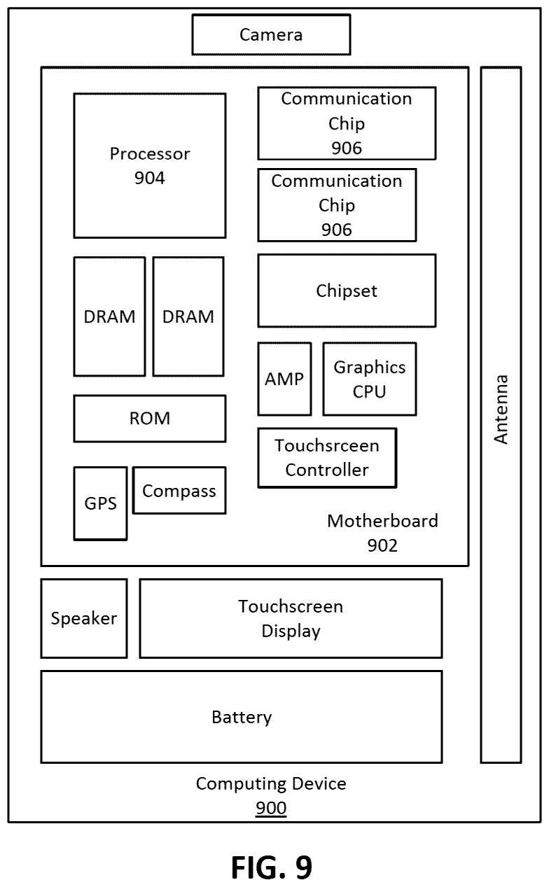

FIG. 9 illustrates a computing device 900 in accordance with one implementation of the disclosure. The computing device 900 houses a board 902. The board 902 may include a number of components, including but not limited to a processor 904 and at least one communication chip 906. The processor 904 is physically and electrically coupled to the board 902. In some implementations the at least one communication chip 906 is also physically and electrically coupled to the board 902. In further implementations, the communication chip 906 is part of the processor 904.

Depending on its applications, computing device 900 may include other components that may or may not be physically and electrically coupled to the board 902. These other components include, but are not limited to, volatile memory (e.g., DRAM), non-volatile memory (e.g., ROM), flash memory, a graphics processor, a digital signal processor, a cryptoprocessor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter-range wireless communications such as Wi-Fi and Bluetooth and a second communication chip 906 may be dedicated to longer-range wireless communications such as GPS, EDGE, GPRS, CDMA, WiMAX, LTE, Ev-DO, and others.

The processor 904 of the computing device 900 includes an integrated circuit die packaged within the processor 904. In some implementations of the disclosure, the integrated circuit die of the processor includes a substrate with V-grooves and corresponding fiber stop trenches that form X-stops, in accordance with implementations of embodiments of the disclosure. The term “processor” may refer to any device or portion of a device that processes electronic data from registers and/or memory to transform that electronic data into other electronic data that may be stored in registers and/or memory.

The communication chip 906 also includes an integrated circuit die packaged within the communication chip 906. In accordance with another implementation of embodiments of the disclosure, the integrated circuit die of the communication chip 906 includes a substrate with V-grooves and corresponding fiber stop trenches that form X-stops, in accordance with implementations of embodiments of the disclosure.

In further implementations, another component housed within the computing device 900 may contain an integrated circuit die that includes a substrate with V-grooves and corresponding fiber stop trenches that form X-stops, in accordance with implementations of embodiments of the disclosure.

In various implementations, the computing device 900 may be a laptop, a netbook, a notebook, an ultrabook, a smartphone, a tablet, a personal digital assistant (PDA), an ultra-mobile PC, a mobile phone, a desktop computer, a server, a printer, a scanner, a monitor, a set-top box, an entertainment control unit, a digital camera, a portable music player, or a digital video recorder. In further implementations, the computing device 900 may be any other electronic device that processes data.

Thus, embodiments described herein include a V-groove fiber stop.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above-detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.
Example embodiment 1: A device comprising a silicon substrate and a waveguide on the silicon substrate. A groove is in the substrate, the groove having a sloped rear wall adjacent to the waveguide. A trench is in the substrate, the trench along a second direction generally orthogonal to the first direction across the sloped rear wall, the trench having a vertical wall at an intersection with the sloped rear wall. An optical fiber in the groove with one end of the optical fiber abutting the vertical wall.
Example embodiment 2: The device of embodiment 1, wherein the vertical wall is between 10-20 μm from the waveguide.
Example embodiment 3: The device of embodiment 1 or 2, further comprising a plurality of grooves in the substrate, and wherein the trench comprises a single continuous trench extending across the plurality grooves.
Example embodiment 4: The device of embodiment 1, 2, or 3, further comprising a plurality of grooves in the substrate, wherein the trench is non-continuous across each groove of the plurality of grooves.
Example embodiment 5: The device of embodiment 1, 2, 3, or 4, wherein the fiber stop trench is between 150-200 μm deep.
Example embodiment 6: The device of embodiment 1, 2, 3, 4, or 5, wherein the trench comprises a first trench, the device further comprising a second trench in the substrate adjacent to the first trench.
Example embodiment 7: The device of embodiment 1, 2, 3, 4, 5, or 6, wherein a depth of the second trench ranges from of 180-260 μm.
Example embodiment 8: The device of embodiment 1, 2, 3, 4, 5, 6, or 7, wherein the groove has a cross-section that is U-shaped, square-shaped, or V-shaped.
Example embodiment 9: The device of embodiment 1, 2, 3, 4, 5, 6, 7, or 8, wherein the groove is approximately 80 μm deep.
Example embodiment 10: A device comprises a photonic integrated circuit (PIC) having a substrate. A set of grooves is in the substrate, where grooves in the set of grooves have two sloped sidewalls and a sloped rear wall. A set of one or more trenches is along a second direction generally orthogonal to the first direction across the sloped rear wall of the grooves, the one or more trenches having a vertical wall at an intersection with the sloped rear wall of the grooves. A respective optical fiber is in the grooves with one end of the respective optical fiber abutting the vertical wall of the grooves.
Example embodiment 11: The device of embodiment 10, wherein the trench comprises a first trench, the device further comprising a second trench along the second direction across the set of grooves.
Example embodiment 12: The device of embodiment 11, wherein a gap exists between the second trench and the vertical wall.
Example embodiment 13: The device of embodiment 11 or 12, wherein the second trench is located approximately 50-60 μm from the first trench.
Example embodiment 14: The device of embodiment 10, 11, 12, or 13, further comprising a waveguide on the substrate, wherein the vertical wall is between 10-20 μm from the waveguide.
Example embodiment 15: The device of embodiment 10, 11, 12, 13, or 14, wherein the trench comprises a single continuous fiber trench that extends across the set of grooves.
Example embodiment 16: The device of embodiment 10, 11, 12, 13, 14, or 15, wherein the trench is non-continuous so that grooves in the set of grooves include a respective trench.
Example embodiment 17: A method for fabricating a device, comprises performing a first etch process through a dielectric stack to expose a substrate where grooves will be formed. A second etch process is performed to form a plurality of grooves along a first direction of the substrate such that ones of the grooves in the plurality of grooves has sloped sidewalls, a bottom, and a sloped rear wall. A third etch process is performed to create a trench across the sloped rear wall of the ones of the grooves that form a vertical wall at an intersection with the sloped rear wall. An adhesive material is deposited into a bottom of the grooves and an optical fiber of an optical fiber array is inserted into respective ones of grooves.
Example embodiment 18: The method of embodiment 17, further comprising: performing the first etch process with a dry etch.
Example embodiment 19: The method of embodiment 17 or 18, further comprising: performing the second etch process with a wet etching using a Tetramethylammonium hydroxide (TMAH) or a KOH etching process.
Example embodiment 20: The method of embodiment 17, 18 or 19, further comprising: performing the third etch process with a dry etch.

What is claimed is:

1. A device, comprising:
a silicon substrate;
a waveguide on the silicon substrate;
a groove in the substrate, the groove having a sloped rear wall adjacent to the waveguide;
a trench in the substrate, the trench along a second direction generally orthogonal to the first direction across the sloped rear wall, the trench having a vertical wall at an intersection with the sloped rear wall; and
an optical fiber in the groove with one end of the optical fiber abutting the vertical wall.

2. The device of claim 1, wherein the vertical wall is between 10-20 μm from the waveguide.

3. The device of claim 1, further comprising a plurality of grooves in the substrate, and wherein the trench comprises a single continuous trench extending across the plurality grooves.

4. The device of claim 1, further comprising a plurality of grooves in the substrate, wherein the trench is non-continuous across each groove of the plurality of grooves.

5. The device of claim 1, wherein the trench is between 150-200 μm deep.

6. The device of claim 1, wherein the trench comprises a first trench, the device further comprising a second trench in the substrate adjacent to the first trench.

7. The device of claim 6, wherein a depth of the second trench ranges from 180-260 μm.

8. The device of claim 1, wherein the groove has a cross-section that is U-shaped, square-shaped, or V-shaped.

9. The device of claim 1, wherein the groove is approximately 80 μm deep.

10. A device, comprising:
a photonic integrated circuit (PIC) having a substrate;
a set of grooves in the substrate, where grooves in the set of grooves have two sloped sidewalls and a sloped rear wall;
a set one or more trenches along a second direction generally orthogonal to the first direction across the sloped rear wall of the grooves, the one or more trenches having a vertical wall at an intersection with the sloped rear wall of the grooves; and
a respective optical fiber in the grooves with one end of the respective optical fiber abutting the vertical wall of the grooves.

11. The device of claim 10, wherein the trench comprises a first trench, the device further comprising a second trench along the second direction across the set of grooves.

12. The device of claim 11, wherein a gap exists between the second trench and the vertical wall.

13. The device of claim 12, wherein the second trench is located approximately 50-60 μm from the first trench.

14. The device of claim 10, further comprising a waveguide on the substrate, wherein the vertical wall is between 10-20 μm from the waveguide.

15. The device of claim 10, wherein the trench comprises a single continuous trench extending across the set of grooves.

16. The device of claim 10, wherein the trench is non-continuous so that grooves in the set of grooves include a respective trench.

17. A method for fabricating a device, comprising:
performing a first etch process through a dielectric stack to expose a substrate where grooves will be formed;
performing a second etch process to form a plurality of grooves along a first direction such that ones of the grooves in the plurality of grooves has sloped sidewalls, a bottom, and a sloped rear wall;
performing a third etch process to create a trench across the sloped rear wall of the ones of the grooves that form a vertical wall at an intersection with the sloped rear wall;
depositing an adhesive material into a bottom of the plurality of grooves; and
inserting an optical fiber of an optical fiber array into respective ones of the plurality of grooves.

18. The method of claim 17, further comprising: performing the first etch process with a dry etch.

19. The method of claim 17, further comprising: performing the second etch process with a wet etching using a Tetramethylammonium hydroxide (TMAH) or a KOH etching process.

20. The method of claim 17, further comprising: performing the third etch process with a dry etch.
